(19) United States
(12) Patent Application Publication
(10) Pub. No.: US 2009/0083178 A1
(43) Pub. Date: Mar. 26, 2009

(54) METHOD AND APPARATUS FOR PROVIDING MORTGAGE

(76) Inventors: Scott Nash, Gaithersburg, MD (US); Christopher Russell, Gaithersburg, MD (US); Ryan Hill, Gaithersburg, MD (US)

Correspondence Address: Mr. Walter J. Tencza Jr., Suite 3, 10 Station Place, Metuchen, NJ, 08840, US

(21) Appl. No.: 11/860,287

(22) Filed: Sep. 24, 2007

(51) Int. Cl. G06Q 40/00

(52) U.S. Cl. 705/39

(57) ABSTRACT

A method is provided including collecting a first upfront enhancement fee from a first party to a sale involving a first real property, placing the first upfront enhancement fee into a pool account having a plurality of upfront enhancement fees, and lending a first amount of money to a borrower who is purchasing the first real property as part of a first loan, wherein the terms of the first loan are more favorable because of the first upfront enhancement fee. The method may further include retaining and servicing the first loan, and retaining the first upfront enhancement fee in the pool account as a loss reserve.

### FIELD OF THE INVENTION

This invention relates to improved methods and apparatus concerning the origination of a mortgage.

### BACKGROUND OF THE INVENTION

Individuals lacking downpayment funds, have difficulty getting mortgages with favorable terms. For example, individuals without savings for a downpayment may currently only be able to get mortgages with higher than market rate interest rates and by paying mortgage insurance. In addition, it is difficult for such individuals to get high loan to value (“LTV”) mortgages (loans or mortgages typically done with less than a 20% down payment) when they have limited credit history. Currently, internal and external credit enhancements are provided to protect the holders of mortgage backed securities to receive a stable return on investment. Internal credit enhancements are financed typically through part of the interest rate that borrowers pay being used to fund a loss pool, while external credit enhancements are used when a borrower pays a monthly payment to a mortgage insurance company which in turn protects the holder of mortgage backed security against loss.

### SUMMARY OF THE INVENTION

One or more embodiments of the present invention provide a fee enhanced mortgage.

In one embodiment of the present invention an upfront enhancement fee is paid to a lender by any party to a first real property transaction, either directly or indirectly. The upfront enhancement fee allows the lender to provide a loan and/or mortgage for the first real property at more favorable terms than if the upfront enhancement fee was not provided. In one embodiment the upfront enhancement fee is paid by the seller of the first real property.

In at least one embodiment a method is provided comprising the steps of collecting a first upfront enhancement fee from a first party to a sale involving a first real property, and placing the first upfront enhancement fee into a pool account having a plurality of upfront enhancement fees. The method may also include lending a first amount of money to a borrower who is purchasing the first real property as part of a first loan, wherein the terms of the first loan are more favorable because of the first upfront enhancement fee. The method may further include retaining and servicing the first loan, and retaining the first upfront enhancement fee in the pool account. The first loan may be a mortgage.

In another embodiment, a method is provided of providing a mortgage from a mortgagee to a mortgagor is provided. The method may include funding a loan by supplying money to the mortgagor from the mortgagee, using the money provided by the mortgagee to pay a property seller for a subject real property, and having the property seller pay an enhancement fee to a pool account in order to fund a loss reserve.

The enhancement fee may be equal to approximately a percentage of the money supplied to the mortgagor from the mortgagee. The method may further include paying monthly payments from the mortgagor for the money previously received from the mortgagee, and having the mortgagee collect the monthly payments from the mortgagor, retain servicing fees from the monthly payments, and pass the monthly payments minus the servicing fees to investors through a securitization vehicle.

The securitization vehicle is a pool of securitized loans. Each of the investors may receive money from the pool of securitized loans per the terms of an investment scheme. If monthly payments from the mortgagor are not received by the mortgagee, the method may include having the mortgagee sell the subject real property, pass at least a portion of the proceeds of the sale to the investors, and pass at least a portion of the loss reserve to the investors. If all loans in the securitization vehicle have been satisfied, a residual amount in the loss reserve may be passed to the investors.

The present invention, in one embodiment, provides an apparatus including a processor. The processor may be configured to collect a first upfront enhancement fee from a first party to a sale involving a first real property, place the first upfront enhancement fee into a pool account having a plurality of upfront enhancement fees, lend a first amount of money to a borrower who is purchasing the first real property as part of a first loan, wherein the terms of the first loan are more favorable because of the first upfront enhancement fee, retain and service the first loan; and retain the first upfront enhancement fee in the pool account.

In another embodiment a processor may be configured to fund a loan by supplying money to a mortgagor from a mortgagee, confirm that the money provided by the mortgagee has been used to pay a property seller for a subject real property, receive an enhancement fee from the property seller, and place the enhancement fee into a pool account in order to fund a loss reserve.

### BRIEF DESCRIPTION OF THE DRAWINGS

FIG. 1 shows a diagram of a flow chart for a method in accordance with an embodiment of the present invention;

FIG. 2 shows an apparatus for implementing a method in accordance with an embodiment of the present invention;

FIG. 3 shows a block diagram of a first state for a system, apparatus, and/or method in accordance with an embodiment of the present invention;

FIG. 4 shows a block diagram of a second state for the system, apparatus, and/or method of FIG. 3;

FIG. 5 shows a block diagram of a third state for the system, apparatus, and/or method of FIG. 3; and

FIG. 6 shows a block diagram of a fourth state for the system, apparatus, and/or method of FIG. 3.

### DETAILED DESCRIPTION OF THE DRAWINGS

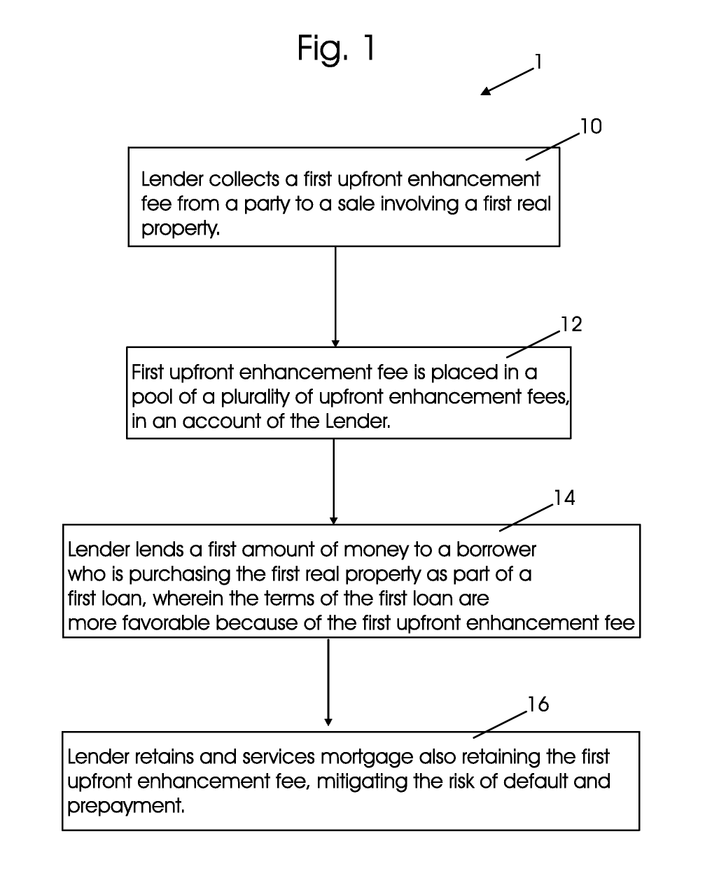

FIG. 1 shows a diagram of a flow chart 1 for a method in accordance with an embodiment of the present invention. At step 10, a lender collects a first upfront enhancement fee from a party to a sale involving a first real property. The party to the sale may be the seller, buyer, real estate salesperson, mortgage lender, or any other entity or party related, directly or indirectly, to those parties, individually or as a group, of the first real property.

In one embodiment, an upfront enhancement fee is collected from the seller of the first real property. The seller typically pays, at closing, the first upfront enhancement fee as agreed in a written sales contract.

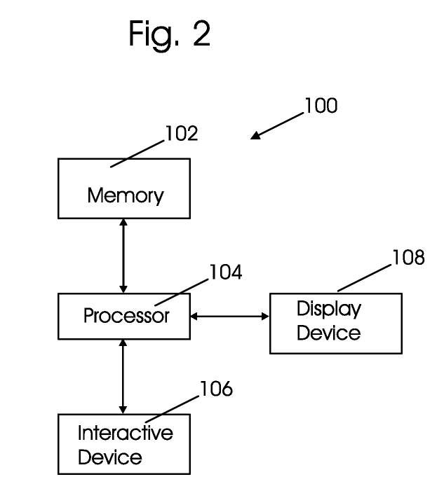

At step 12, the first upfront enhancement fee is placed in a pool and/or account controlled by the lender. The account and/or pool includes a plurality of upfront enhancement fees from a plurality of real property sales. A variation of this, such as shown in FIG. 2, is that the lender uses the upfront enhancement fee to reduce the pricing of bonds created as collateralized debt obligations (CDO's) that are sold to investors. This would allow for a premium rating of the less risky pieces (CDO's) of the loan.

At step 14, the lender lends a first amount of money to a borrower who is purchasing the first real property as part of a first loan. The terms of the first loan are more favorable because of the payment of the first upfront enhancement fee.

At step 16, if the borrower defaults on the first loan, funds in the reserve pool that were collected from property seller's, or other interested parties to the first real estate transaction, which are being held by the servicing company and being owned by the lender, are used to cover any loss on to the mortgage investor from the sale of the property. In an example of using these funds to improve the pricing of Collateralized Debt Obligations (CDO's), these funds are included in the original sale of the bonds and are already in possession of the investor. The investor receives nothing additional on its collateralized debt obligation bond. The lender retains and services mortgage also retaining the first upfront enhancement fee, mitigating the risk of default and prepayment.

The first upfront enhancement fee, typically paid by the seller in one embodiment, allows the lender to provide a first loan at more favorable terms, since the lender's risk is reduced and the securities created from the loan provide a more stable return on investment to the bond and derivative investors. For example, the lender could provide a 100% loan to value (“LTV”) mortgage to a buyer who does not have an excellent job history, credit history, or credit score. The lender could also provide a competitive interest rate as opposed to a typically higher interest rate for buyers with a poor credit history. The lender may also be able to provide a mortgage without requiring the buyer to pay for a high mortgage insurance premium or pay a premium interest rate. This product specifically allows the borrower to get a lower interest rate than normally would be obtained for a 100% LTV (loan to value) mortgage.

Although in accordance with one embodiment of the present invention, the seller would typically pay for the first upfront enhancement fee, this method would directly benefit real property buyers and mortgage holders and indirectly benefit all real estate professionals involved in the transaction, such as realtors, loan officers, appraisers, title companies, etc.

The enhancement fees that are charged in one embodiment to the property sellers are pooled together and used to mitigate any losses that occur from mortgage foreclosures or are used to purchase the riskiest piece of the collateralized debt obligations created from the loan into the mortgage backed securities. This product specifically allows the bonds, mortgage backed securities and/or collateralized debt obligations to be rated higher than they would normally rated, allowing for a lower yield and more stable return to the investor.

One embodiment of the present invention product would require no traditional internal or external credit enhancement as the credit enhancement would be funded by the seller paid Enhancement Fee.

FIG. 2 shows an apparatus 100 for implementing a method in accordance with an embodiment of the present invention. The apparatus 100 includes a memory 102, a processor 104, an interactive device 106, and a display device 108. The lender, referred to in FIG. 1, may collect the first upfront enhancement fee and any of the plurality of enhancement fees, electronically through the processor 104, which may represent one or more computer processors. The lender may also place upfront enhancement fees into an account electronically using processor 104 and/or lend money electronically through processor 104. A record of money lent or received by the lender may be kept in memory 102, which may be computer memory. Records of money lent or enhancement fees may be displayed on display device 108, which may be a computer monitor. The interactive device 106 may be used to input enhancement fees, loan information, investor information and/or other data. The interactive device 106 may include a computer keyboard, mouse, or screen. Data may also be entered via the internet or automatically.

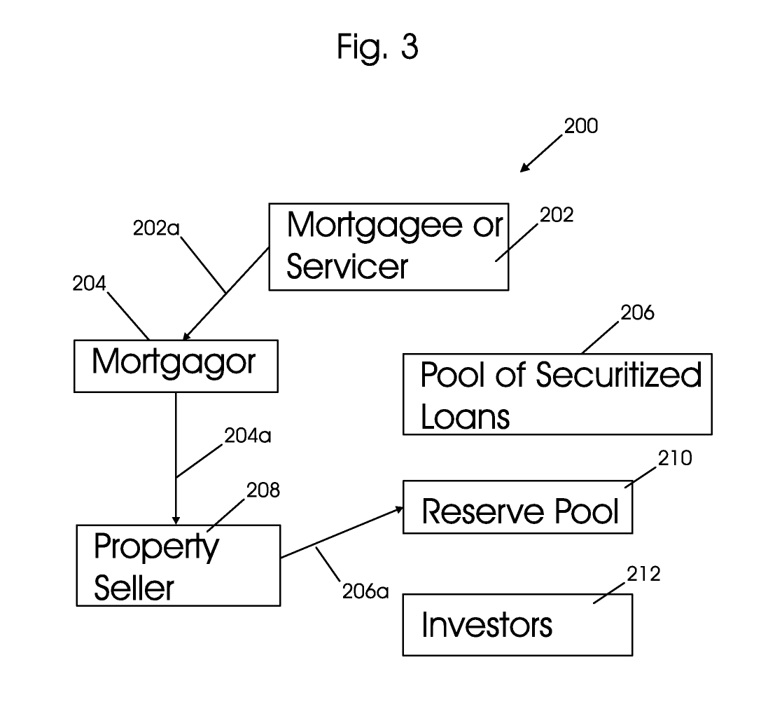

FIG. 3 shows a block diagram 200 of a first state for a system, apparatus, and/or method in accordance with an embodiment of the present invention. The system, apparatus, and/or method in accordance with an embodiment of the present invention may include or employ a mortgagee or servicer 202, a mortgagor (or borrower) 204, a pool of securitized loans 206, a property seller 208, a reserve pool 210, and investors 212. In the first state, shown by FIG. 3, the mortgagee 202 funds a loan such as by supplying money to a mortgagor 204, as shown by line with arrow 202a. The mortgagor 204 uses the money provided by the mortgagee 202 to pay a property seller 208 for a subject property, such as a home, as shown by line with arrow 204a. The property seller 208 pays a fee, as shown by line with arrow 206a, such as an enhancement fee to a reserve pool 210, in order to fund a loss reserve. The enhancement fee may be, for example, 3.5% of the purchases price of the subject property.

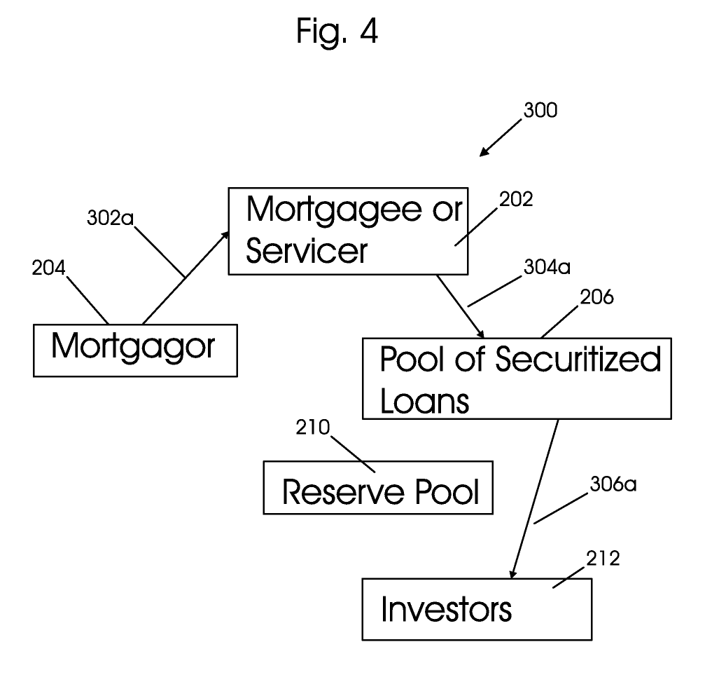

FIG. 4 shows a block diagram 300 of a second state for the system, apparatus, and/or method of FIG. 3. The property seller 208 is not shown in the second state of FIG. 4, since the property seller 208 is no longer involved in the system, apparatus and/or method. In the second state of FIG. 4, the mortgagor (borrower) 204 pays monthly payments, typically, as shown by line with arrow 302a, for the money previously received from the mortgagee 202 in the first state of FIG. 3. The mortgagee 202 collects the monthly payments from the mortgagor 204, retains servicing fees from the monthly payments, and passes the monthly payments minus the servicing fees to investors through a securitization vehicle, which in this case is a pool of securitized loans 206 as shown by line with arrow 304a and line with arrow 306a. The investors 212 receive money from the pool of securitized loans 206 per the terms of their investment scheme.

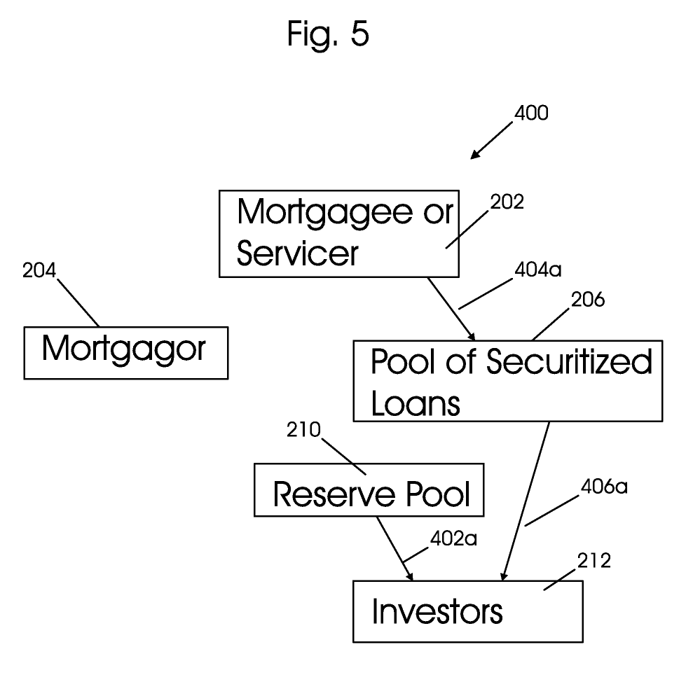

FIG. 5 shows a block diagram 400 of a third state for the system, apparatus, and/or method of FIG. 3. In the third state, the mortgagor (borrower) 204 fails to make monthly payments and the subject property is sold for less than the balance owed on the mortgage (loan). In the third state, the mortgagee 202 sells the subject property and passes the proceeds onto the pool of securitized loans 206 as shown by line with arrow 404a. The proceeds from the sale are passed to investors 212 from the pool 206 as shown by line with arrow 406a. In addition, money is taken from the reserve pool 210 and provided to investors 212 as shown by line with arrow 402a, to make up for any loss suffered by investors 212.

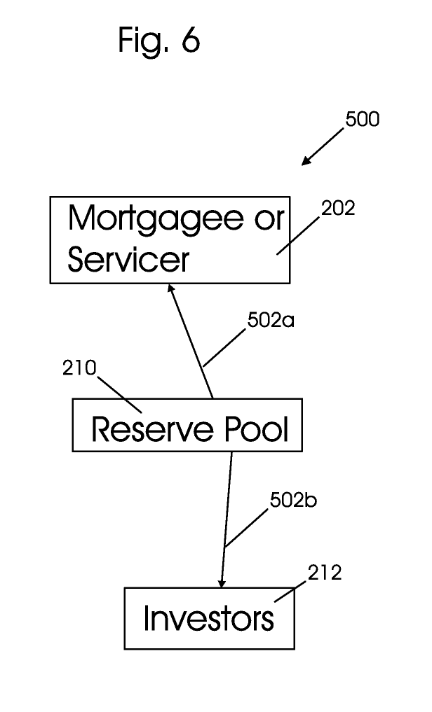

FIG. 6 shows a block diagram 500 of a fourth state for the system, apparatus, and/or method of FIG. 3. In FIG. 6, all loans in the securitization pool have been satisfied. The money remaining, if any, in the reserve pool 210 may go to the mortgagee 202 as shown by line with arrow 502a or to the investors 212 as shown by line with arrow 502b, depending upon an agreement between mortgagee 202 and the investors 212.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising the steps of
collecting a first upfront enhancement fee from a first party to a sale involving a first real property;
placing the first upfront enhancement fee into a pool account having a plurality of upfront enhancement fees;
lending a first amount of money to a borrower who is purchasing the first real property as part of a first loan, wherein the terms of the first loan are more favorable because of the first upfront enhancement fee;
retaining and servicing the first loan; and
retaining the first upfront enhancement fee in the pool account.

2. The method of claim 1 wherein
the first loan is a mortgage.

3. A method of providing a mortgage from a mortgagee to a mortgagor comprising
funding a loan by supplying money to the mortgagor from the mortgagee;
using the money provided by the mortgagee to pay a property seller for a subject real property; and
having the property seller pay an enhancement fee to a pool account in order to fund a loss reserve.

4. The method of claim 3 wherein
the enhancement fee is approximately a percentage of the money supplied to the mortgagor from the mortgagee.

5. The method of claim 4 wherein
the enhancement fee is approximately three and one half percent of the money supplied to the mortgagor from the mortgagee.

6. The method of claim 3 further comprising
paying monthly payments from the mortgagor for the money previously received from the mortgagee; and
having the mortgagee collect the monthly payments from the mortgagor, retain servicing fees from the monthly payments, and pass the monthly payments minus the servicing fees to investors through a securitization vehicle.

7. The method of claim 6 wherein
the securitization vehicle is a pool of securitized loans.

8. The method of claim 7 wherein
each of the investors receives money from the pool of securitized loans per the terms of an investment scheme.

9. The method of claim 6 wherein
if monthly payments from the mortgagor are not received by the mortgagee, having the mortgagee sell the subject real property, pass at least a portion of the proceeds of the sale to the investors, and pass at least a portion of the loss reserve to the investors.

10. The method of claim 9 wherein
if all loans in the securitization vehicle have been satisfied, passing a residual amount in the loss reserve to the investors.

11. An apparatus comprising
a processor configured to:
collect a first upfront enhancement fee from a first party to a sale involving a first real property;
place the first upfront enhancement fee into a pool account having a plurality of upfront enhancement fees;
lend a first amount of money to a borrower who is purchasing the first real property as part of a first loan, wherein the terms of the first loan are more favorable because of the first upfront enhancement fee;
retain and service the first loan; and
retain the first upfront enhancement fee in the pool account.

12. The apparatus of claim 11 wherein
the first loan is a mortgage.

13. An apparatus comprising a processor configured to
fund a loan by supplying money to a mortgagor from a mortgagee;
confirm that the money provided by the mortgagee has been used to pay a property seller for a subject real property;
receive an enhancement fee from the property seller; and
place the enhancement fee into a pool account in order to fund a loss reserve.

14. The apparatus of claim 13 wherein
the enhancement fee is approximately a percentage of the money supplied to the mortgagor from the mortgagee.

15. The apparatus of claim 13 wherein the processor is further configured to
confirm that monthly payments are paid from the mortgagor for the money previously received from the mortgagee; and
collect the monthly payments from the mortgagor;
retain servicing fees from the monthly payments;
and pass the monthly payments minus the servicing fees to investors through a securitization vehicle.

16. The apparatus of claim 15 wherein
the securitization vehicle is a pool of securitized loans.

17. The apparatus of claim 16 wherein the processor is configured to
provide each of the investors with money from the pool of securitized loans per the terms of an investment scheme.

18. The apparatus of claim of claim 15 the processor is configured to
cause the subject real property to be sold if monthly payments from the mortgagor are not received by the mortgagee;
pass at least a portion of the proceeds of the sale to the investors,
and pass at least a portion of the loss reserve to the investors.

19. The apparatus of claim 18 the processor is configured to
pass a residual amount in the loss reserve to the investors, if all loans in the securitization vehicle have been satisfied.
